(19) United States
(12) Patent Application Publication
(10) Pub. No.: US 2024/0007549 A1
(43) Pub. Date: Jan. 4, 2024

(54) Method and device for switching an item of application data

(71) Applicant: ORANGE, Issy-les-Moulineaux (FR)

(72) Inventor: Lionel Morand, Chatillon Cedex (FR)

(21) Appl. No.: 18/250,094

(22) PCT Filed: Oct. 14, 2021
(86) PCT No.: PCT/FR2021/051789

§ 371 Date: Apr. 21, 2023

(30) Foreign Application Priority Data
Oct. 23, 2020 (FR) 2010883

(51) Int. Cl. H04L 69/326; H04L 69/22; H04L 1/00

(52) U.S. Cl. CPC H04L 69/326; H04L 69/22; H04L 1/0061

(57) ABSTRACT

A method for switching an item of data relating to an application transported in a data fragment of a packet of a stream transport protocol, such as the Stream Control Transport Protocol. The method is implemented by a multiplexing device able to transfer data relating to a plurality of applications to processing entities, using a first destination port identifier common to the plurality of applications, and, in a data fragment, a second identifier specific to the application.

### 1. TECHNICAL FIELD

The invention lies in communication networks, and more precisely in networks in which data streams are routed using a stream transport protocol, such as the SCTP (Stream Control Transport Protocol) protocol, these data streams relating to multiple applications. The invention aims more particularly to be able to unambiguously distinguish data relating to multiple applications transported simultaneously on the same transport protocol.

### 2. PRIOR ART

Network architectures that are specified and deployed nowadays are based on a layered communication system in which each layer is responsible for a routing service. The Internet architectures currently used for a variety of needs and services are thus based on the TCP/IP (Transmission Control Protocol/Internet Protocol) protocols comprising a set of protocols. Among these layers, a distinction is drawn between the IP layer, making it possible in particular to reach a correspondent using an IP address, and the transport layer, ensuring in particular the correct routing of data between two correspondents and the integrity of these data. Among the transport protocols, the UDP (User Data Protocol) and TCP protocols and also the SCTP protocol specified in document IETF RFC 4960 (September 2007) are in particular identified. This SCTP protocol has in particular features in terms of reliability, redundancy, security and reliability that are particularly relevant for constricted services, such as telephony over IP services. It should also be noted that the transport protocols used in networks route data streams for various applications. The application data routed via the transport protocols, including the SCTP protocol, are thus multiplexed using a common IP address and using a port number relating to the transport protocol associated with a specific application. Thus, as indicated in [FIG. 1], a node 400 transmitting application data of the applications App1, App2 to a node 410 transmits IP packets comprising the (source) IP address of the node 400, the (destination) IP address of the node 410, the (source) port PS of the transport protocol, the (destination) port of the SCTP transport protocol. In modern architectures, the destination port that is used unambiguously identifies the application data transported above the transport protocol. Thus, the data of the application App1 will be identified by a destination port P1, and the data of the application App2 will be identified by a destination port P2. The transport layer thus routes data streams of multiple applications App1, App2 by differentiating these streams with specific port numbers P1 and P2.

The node 410 is thus capable of transmitting the data received from the node 400 and relating to the applications App1, App2 to the entities responsible for the applications App1, App2 by analyzing the destination port used on the SCTP transport protocol level. For each application deployed in the networks, in modern techniques, in particular when the application is used on the public Internet, it is necessary to allocate a port of the transport protocol. It is thus necessary to call upon the IANA (https://www.iana.org/assignments/service-names-port-numbers/service-names-port-numbers.xhtml) that allocates these ports. However, allocation procedures are becoming increasingly strict, since IANA is afraid of seeing all port numbers assigned and of having a lack of port numbers. It thus becomes very difficult to obtain these port numbers. Furthermore, in the case of deploying what is called a private network, that is to say a network managed by an entity and not needing to communicate with what are called public networks over the Internet, IANA has greatly restricted the possibility of resorting to the allocation of public port numbers, this posing problems in terms of a conflict of numbers and the management of these port numbers, in particular in the case of interconnection with other what are called private networks. This unavailability of the port numbers of the transport layer, and in particular for the SCTP protocol, therefore poses problems in terms of deploying services and applications. It should be noted that the TCPMux protocol defined in document IETF RFC 1078 describes a method for multiplexing application streams, but this method is specific to the TCP protocol (November 1998), and implementing it poses problems in particular in terms of security, thereby making it ineffective for the needs described above.

The present invention aims to make improvements over the prior art.

### 3. DISCLOSURE OF THE INVENTION

The invention aims to improve the situation by way of a method for switching a datum relating to an application transported in a data fragment of a packet of a stream transport protocol, such as the Stream Control Transport Protocol, implemented by a multiplexing device able to transfer data relating to a plurality of applications to processing entities, and comprising receiving, from a terminal device, the packet of the stream transport protocol comprising a header containing a first destination port identifier common to the plurality of applications, and the data fragment comprising a second identifier specific to the application, determining the application on the basis of the first and the second identifier that are received and, if the application is determined, transmitting the datum to an entity responsible for processing the datum of the application.

A multiplexing device receiving multiple packets of the transport protocol, such as SCTP, is thus able to transfer the application data to the various entities responsible for receiving, processing and possibly constructing a response on the basis of the two identifiers present in the header and each of the fragments transporting the application data. For example, if two Voice over IP and Video over IP applications are activated, the switching device present for example in a Voice over IP client will receive the Voice over IP and Video over IP streams and will transmit the Voice over IP data to the process managing the Voice over IP sessions and the Video over IP data to the process managing the Video over IP application, possibly deployed on a terminal other than the Voice over IP client. This method thus makes it possible to save on the destination ports used to multiplex the application streams in a connection on the transport level while at the same time ensuring the multiplexing method needed to transmit separate application streams on one and the same connection between two equipments. The multiplexing device comprises means for being able to analyze the received identifiers and also determining whether the two identifiers correspond to an application for which the multiplexing device is able to manage data.

The switching method thus makes it possible to unambiguously differentiate data relating to multiple applications transported simultaneously on the same transport protocol.

According to one aspect of the invention, the switching method furthermore comprises transmitting an error message to the terminal device if an application is not determined.

The terminal device may advantageously be informed of a problem in terms of selecting identifiers, parameterizing identifiers, and/or of a problem in terms of the compatibility of the switching device in order to be able, where applicable, to change the switching device, initialize a new SCTP connection and/or verify one or the other of the transmitted identifiers.

According to another aspect of the invention, in the switching method, the error message is a packet of the stream transport protocol comprising a fragment containing an Abort error code.

The use of an Abort message, that is to say the sending of a fragment comprising an item of Abort information, makes it possible to be able to terminate the SCTP association between the terminal device and the switching device and to resort to a message defined in the specification of the SCTP protocol.

According to another aspect of the invention, in the switching method, the error message comprises a cause of failure intended for the application implemented in the terminal device.

As indicated above, various causes may bring about the receipt of an error message from the switching device. It is therefore advantageous to provide causes of failure corresponding to the problems that the switching device may encounter, and thus allow the terminal device to be able to resort to a suitable solution with respect to the received cause of failure.

According to another aspect of the invention, in the switching method, the first destination port identifier is a port identifier dedicated to the switching method.

The destination port identifier may be a port dedicated to the switching method, thus allowing the switching device to resort directly, and without any further examination of the packets, to a switching process. On the other hand, a port dedicated to the switching method avoids problems in terms of a conflict of identifiers if one and the same identifier is used for two separate methods or two separate applications. Such a dedicated port may thus be implemented in a public network (the Internet) or a private network (mobile network based on the 3GPP specifications).

According to another aspect of the invention, in the switching method, the first destination port identifier is a port identifier already allocated for the TCPMux protocol.

The TCPMux protocol already uses a specific port for the multiplexing of application streams on a TCP connection using a method separate from the switching method. However, in particular if the TCPMux protocol and the switching method are used by one and the same entity, the use of one and the same port identifier for the two methods has the advantage of simplifying the management of multiplexing services based on one or the other of the protocols and method.

According to another aspect of the invention, in the switching method, the first destination port identifier is a port identifier allocated for an application based on the SCTP protocol.

The first destination port identifier may be an identifier of an SCTP application, and therefore an identifier already used for another purpose, making it possible not to resort to a specific identifier and thus preserving the identifiers to be used for the applications and methods based on SCTP.

The various aspects of the switching method that have just been described may be implemented independently of one another or in combination with one another.

The invention also relates to a method for configuring a packet of a stream transport protocol such as the Stream Control Transport Protocol, the packet comprising a header and a data fragment, the method being implemented by a terminal device able to transmit a datum relating to an application to a multiplexing device, and comprising parameterizing the packet with a first destination port identifier in the header and with a second identifier specific to the application in the data fragment, and transmitting the parameterized packet to the multiplexing device.

According to another aspect of the invention, the configuration method furthermore comprises receiving an error message if no application is determined by the multiplexing device based on the first identifier and the second identifier that are parameterized.

The various aspects of the configuration method that have just been described may be implemented independently of one another or in combination with one another.

The invention also relates to a switching device able to transfer data relating to a plurality of applications to processing entities, one of the data being transported in a data fragment of a packet of a stream transport protocol, such as the Stream Control Transport Protocol, comprising
a receiver, able to receive, from a terminal device, the packet of the stream transport protocol comprising a header containing a first destination port identifier common to the plurality of applications, and the data fragment comprising a second identifier specific to the application,
a determination module, able to determine the application on the basis of the first and the second identifier that are received,
a transmitter, able to transmit the datum to an entity responsible for processing the datum of the application if the application is determined.

This device, which is able, in all of its embodiments, to implement the switching method that has just been described, is intended to be implemented in an application server, in a router of a communication network or of an intermediate equipment (DPI (Deep Packet Inspection) or firewall) or else in an equipment of a mobile network (access gateway, server in an MEC (Mobile Edge Computing) architecture). The device 100 may also be implemented in a user equipment.

The invention also relates to a device for configuring a packet of a stream transport protocol such as the Stream Control Transport Protocol, the packet comprising a header and a data fragment, comprising
a parameterization module, able to parameterize the packet with a first destination port identifier in the header and with a second identifier specific to an application in the data fragment,
a transmitter, able to transmit the parameterized packet to a multiplexing device.

This device, which is able, in all of its embodiments, to implement the configuration method that has just been described, is intended to be implemented in a user equipment or else a gateway of a personal network. It may also be implemented in an application server, in a router of a communication network or of an intermediate equipment (DPI (Deep Packet Inspection) or firewall) or else in an equipment of a mobile network (access gateway, server in an MEC (Mobile Edge Computing) architecture).

The invention also relates to a system for switching a datum relating to an application transported in a fragment of a packet of a stream transport protocol, such as the Stream Control Transport Protocol, comprising
a multiplexing device comprising a switching device,
a terminal device comprising a configuration device.

The invention also relates to computer programs comprising instructions for implementing the steps of the respective switching and configuration methods that have just been described when these programs are each executed by a processor, and to a recording medium able to be read respectively by a switching device and a configuration device and on which the computer programs are recorded.

The invention furthermore aims to improve the situation by way of a method for mediating a plurality of user applications by way of an application relating to the stream control transport protocol, such as the Stream Control Transport Protocol, called generic application, the method being implemented in a proxy device, able to establish a connection based on the stream transport protocol with a terminal device, and comprising receiving, from the terminal device, a request packet of the stream control transport protocol comprising a data fragment containing an identifier of a user application requested by the terminal device, verifying that the requested user application is an application of the plurality, and if the requested user application is an application of the plurality, transmitting a consent message to the terminal device.

The association of an SCTP connection between the terminal device and the proxy device is established through an exchange of INIT, INIT ACK, COOKIE-ECHO and COOKIE-ACK messages. Once the association has been established, the devices are able to exchange user application data. The method makes it possible to exchange various user application data (Voice over IP, Video over IP, monitoring, etc.) by resorting to a mediation application, or generic application, implemented in a mediation device. The destination port of the header of the SCTP protocol is thus specific to this mediation application, making it possible to save on ports that would be used to distinguish the data of the user applications, this destination port dedicated to the generic application is furthermore used in the SCTP messages exchanged during the establishment of the association. Once the association has been established, the terminal device transmits a novel and inventive SCTP request message, making it possible to interrogate the proxy device with regard to its ability to provide mediation for the user applications for which it transmits the identifiers. Only if the proxy device is actually able to provide mediation for a user application, the terminal device may transmit data of the user application that the proxy device will be able to transmit to an application server, to a client of the data of the user application or to a process managing the user application deployed on the proxy server. The method therefore allows the terminal device to transmit user data with a guarantee that it will be processed by the proxy device and allows the proxy device to dynamically inform the terminal devices of its user data processing abilities while at the same time also preserving the destination ports used to transport data of the user applications.

According to one aspect of the invention, in the mediation method, the request packet furthermore comprises a header containing a destination port identifier dedicated to the generic application.

Identifying the received request packet is made easier by using the destination port present in the SCTP packets transmitted by the terminal device. Furthermore, if a large number of user applications are managed by the proxy device, it may be advantageous to deploy multiple generic applications, and to distribute the mediation of the user applications over these various generic applications. In this case in particular, using the destination port present in the header of the received SCTP packet is particularly advantageous.

According to one aspect of the invention, in the mediation method, the consent message comprises at least one user application identifier of the plurality accessible from the generic application.

The proxy device effectively uses the received request message to inform the terminal device of its abilities in terms of user applications for which it provides mediation. The received request message may be used to transmit the list of identifiers of the user applications, independently of the identifiers received in the received request message, thus corresponding to a Push method implemented by the proxy device to inform the terminal device.

According to one aspect of the invention, the mediation method furthermore comprises receiving, from the terminal device, an application packet of the stream transport protocol comprising a data fragment containing the identifier specific to the requested user application and an application datum specific to the requested user application, and transmitting the received application datum to the requested user application. The terminal device, for example a user equipment, uses the received consent message and the information present in this message to transmit the application data using application protocols above SCTP to the proxy device, and more specifically the generic application. The advantage of the method is in particular, for the terminal device, that of obtaining application identifiers preventatively (in push mode), allowing it to transmit data relating to these applications without having to send a new SCTP request message.

According to one aspect of the invention, the mediation method comprises transmitting, to the terminal device, a failure message if the identifier of the requested user application does not correspond to a user application of the plurality.

The terminal device may advantageously be informed of a problem in terms of selecting identifiers, parameterizing identifiers, and/or a problem in terms of the compatibility of the proxy device, the availability of the generic application to receive user application data streams, in order to be able, where applicable, to change proxy device, initialize a new SCTP connection and/or verify one or the other of the transmitted identifiers, memorize the data of the user applications to be transmitted.

According to one aspect of the invention, in the mediation method, the failure message is a packet of the stream transport protocol, comprising an Abort fragment terminating an association established between the terminal device and the proxy device.

The use of an Abort message, that is to say the sending of a fragment comprising an item of Abort information, makes it possible to be able to terminate the SCTP association between the terminal device and the proxy device and to resort to a message defined in the specification of the SCTP protocol.

According to one aspect of the invention, in the mediation method, the failure message furthermore comprises a cause of failure intended for the entity of the terminal device requesting the application.

Various problems may bring about the receipt of an error message from the proxy device. It is therefore advantageous to provide causes of failure corresponding to the problems that the proxy device and/or the generic application may encounter, and thus allow the terminal device to be able to resort to an appropriate solution (calling upon another generic application, configuring a new request packet, association with another proxy device) with respect to the received cause of failure.

The various aspects of the mediation method that have just been described may be implemented independently of one another or in combination with one another.

The invention also relates to a method for parameterizing a request packet of a stream control transport protocol, such as the Stream Control Transport Protocol, transmitted to a proxy device, the method being implemented by a terminal device able to communicate with the proxy device, and comprising determining a request packet of the stream control transport protocol, comprising a data fragment comprising an identification datum of a user application requested by the terminal device, and transmitting the determined request packet to the proxy device.

According to one aspect of the invention, the parameterization method furthermore comprises transmitting, to the proxy device, an application packet of the stream transport protocol comprising a data fragment containing an identifier specific to the requested application and an application datum specific to the requested application.

According to one aspect of the invention, in the parameterization method, the determined request packet furthermore comprises a header containing a destination port identifier dedicated to an application relating to the stream control transport protocol, called generic application.

The various aspects of the parameterization method that have just been described may be implemented independently of one another or in combination with one another.

The invention also relates to a device for mediating a plurality of user applications by way of an application relating to a stream control transport protocol, such as the Stream Control Transport Protocol, called generic application, able to establish a connection based on the stream transport protocol with a terminal device, and comprising
a receiver, able to receive, from the terminal device, a request packet of the stream control transport protocol comprising a data fragment containing an identifier of a user application requested by the terminal device,
a verification module able to verify that the requested user application is an application of the plurality,
a transmitter, able to transmit a consent message to the terminal device if the requested user application is an application of the plurality.

This device, which is able, in all of its embodiments, to implement the mediation method that has just been described, is intended to be implemented in an application server, in a router of a communication network or of an intermediate equipment (DPI (Deep Packet Inspection) or firewall) or else in an equipment of a mobile network (access gateway, server in an MEC (Mobile Edge Computing) architecture). The device 100 may also be implemented in a user equipment.

The invention also relates to a device for parameterizing a request packet of a stream control transport protocol, such as the Stream Control Transport Protocol, transmitted to a proxy device, implemented in a terminal device and comprising
a determination module, able to determine a request packet of the stream control transport protocol, comprising a data fragment comprising an identification datum of a user application requested by the terminal device,
a transmitter, able to transmit the determined request packet to the proxy device.

This device, which is able, in all of its embodiments, to implement the parameterization method that has just been described, is intended to be implemented in a user equipment or else a gateway of a personal network. It may also be implemented in an application server, in a router of a communication network or of an intermediate equipment (DPI (Deep Packet Inspection) or firewall) or else in an equipment of a mobile network (access gateway, server in an MEC (Mobile Edge Computing) architecture).

The invention also relates to a system for mediating a plurality of user applications by way of an application relating to a stream control transport protocol, such as the Stream Control Transport Protocol, called generic application, comprising
a proxy device comprising a mediation device,
a terminal device comprising a parameterization device.

The invention also relates to computer programs comprising instructions for implementing the steps of the respective mediation and parameterization methods that have just been described when these programs are each executed by a processor, and to a recording medium able to be read respectively by a mediation device and parameterization device and on which the computer programs are recorded. The abovementioned programs may use any programming language, and be in the form of source code, object code, or intermediate code between source code and object code, such as in a partially compiled form, or in any other desirable form.

The abovementioned information media may be any entity or device capable of storing the program. For example, a medium may comprise a storage means, such as a ROM, for example a CD-ROM or a microelectronic circuit ROM, or else a magnetic recording means.

Such a storage means may for example be a hard disk, a flash memory, etc.

Moreover, an information medium may be a transmissible medium such as an electrical or optical signal, which may be routed via an electrical or optical cable, by radio or by other means. A program according to the invention may in particular be downloaded from a network such as the Internet.

As an alternative, an information medium may be an integrated circuit in which a program is incorporated, the circuit being designed to execute or to be used in the execution of the methods in question.

### 4. BRIEF DESCRIPTION OF THE DRAWINGS

Other features and advantages of the invention will become more clearly apparent upon reading the following description of particular embodiments, which are given by way of simple illustrative and nonlimiting examples, and the appended drawings, in which:

FIG. 1 shows a simplified view of a communication between two nodes according to the prior art,

FIG. 2 shows a simplified view of a communication between two nodes according to one aspect of the invention,

FIG. 3 shows a simplified view of a communication between two nodes according to another aspect of the invention,

FIG. 4 shows an overview of the method for switching a datum relating to an application and of the configuration method according to one embodiment of the invention,

FIG. 5 shows an overview of the method for mediating a plurality of applications by way of a generic application and of the parameterization method according to one embodiment of the invention,

FIG. 6 shows a device for switching a datum relating to an application according to one embodiment of the invention,

FIG. 7 shows a device for configuring a packet of a stream transport protocol according to one embodiment of the invention,

FIG. 8 shows a device for mediating a plurality of applications by way of a generic application according to one embodiment of the invention,

FIG. 9 shows a device for parameterizing a stream control transport protocol packet according to one embodiment of the invention.

### DESCRIPTION OF THE EMBODIMENTS

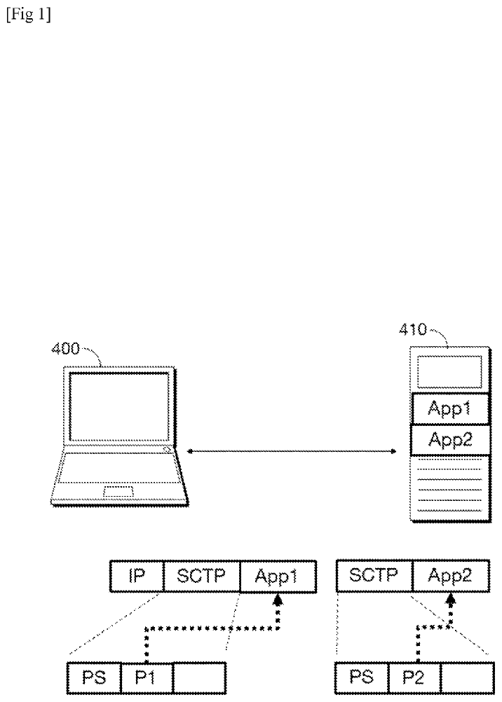

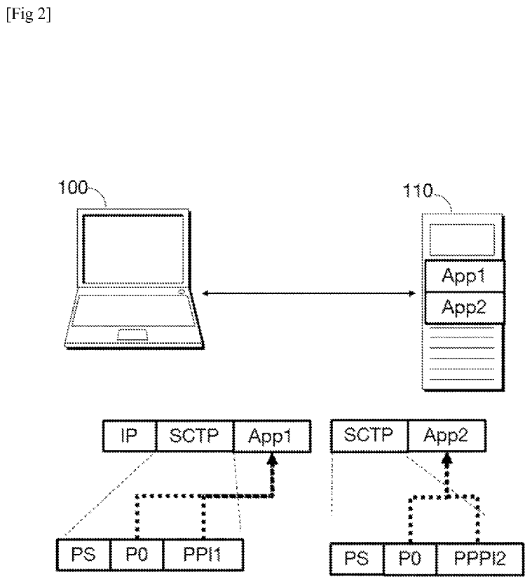

The remainder of the description presents embodiments of the invention in a communication infrastructure. This infrastructure may be implemented in order to route communication data to fixed or mobile terminals, and the invention may be intended to install virtualized functions used for routing and/or processing domestic or company clientele data. Reference is made first of all to [FIG. 2], which shows a simplified view of a communication between two nodes according to one aspect of the invention. As in [FIG. 1] for the nodes 400 and 410, a node 100, corresponding to a terminal device, transmits application data of the applications App1, App2 to a node 110, and transmits IP packets comprising the (source) IP address of the node 100, the (destination) IP address of the node 110, the (source) port PS of the SCTP transport protocol, the (destination) port of the SCTP transport protocol and application data relating to the applications App1 and App2. The nodes 100 and 110 may indifferently be terminals, servers, telephony and/or videophony communication equipments, routing entities and/or management entities of a communication network. The applications App1 and App2 may be applications allowing users of the nodes 100 and 110 to access value-added services, applications for managing a communication network, or indifferently any application the data of which are transported on an Internet network. Only two applications App1 and App2 are shown in [FIG. 1] and [FIG. 2], but there are not a priori any limits with regard to the number of applications able to benefit from the switching method. The SCTP protocol used to transport the data of the applications App1 and App2 comprises a header comprising the source port PS and the destination port P0. Unlike [FIG. 1], in which the destination ports (P1 and P2 as a reminder) distinguished the applications (respectively App1 and App2), the destination port P0 is common to the two applications App1 and App2 and therefore does not make it possible to differentiate the data of the applications App1 and App2. Upon receipt of the SCTP packets, the node 110 corresponding to a multiplexing device comprising a switching device is not able to differentiate the data of the applications App1 and App2 by simply reading and interpreting the destination port in the header of the SCTP protocol. To switch the data of the applications App1 and App2 to the entities or software applications managing these two applications, another item of information present in a data fragment (or data chunk) of the SCTP packet is used in addition to the destination port P0. This item of information is an identifier PPI1 (Payload Protocol Identifier 1) present in each data fragment of the SCTP protocol. Thus, with the first identifier P0 of the header of the SCTP protocol and the second identifier PPI1 of a fragment of the SCTP protocol, the multiplexing device is capable of switching the data of the application App1, corresponding to the identifier P0-PPI1, to the entity responsible for the application App1. Upon receipt of a packet comprising the two identifiers P0 and PPI1, the node 110, which is able to analyze the SCTP packets, verifies that these identifiers correspond to applications for which it is able to switch data and, if so, it transmits the data to the application App1. The application App1 corresponds here to a physical or software entity able to manage the data of the application App1. If the data of the application App1 relate to a Voice over IP service, the data of the application will be able to be transferred to a software entity present on the node 110 or else to another physical entity possibly using a communication protocol between the node 110 and this other physical entity different from the SCTP protocol. In the same way, when the node 110 receives an SCTP packet comprising a header containing a destination port P0 and a fragment comprising an identifier PPI2, if the application App2 corresponding to the identifiers P0 and PPI2 forms part of the applications multiplexed by the node 110, then it transmits the data of the application App2 to the entity responsible for the application App2. The implementation of the invention presented in [FIG. 2] is symmetrical and the nodes 100 and 110 may be swapped, the node 100 possibly corresponding to the multiplexing device and the node 110 possibly corresponding to a terminal device. The two nodes 100 and 110 may thus comprise multiplexing devices, each node 100 and 110 possibly comprising a configuration device and a multiplexing device. During a bidirectional communication, one of the two nodes plays the role of the multiplexing device and the other node plays the role of the configuration device. It should be noted that, as part of a bidirectional communication, the application data transmitted by the node 110 or via the node 110 to the node 100 are transmitted in SCTP packets in accordance with the specifications of the protocol, in particular using the source IP address, destination IP address, source port and destination port information.

According to one example, if the identifiers received by the node 110 correspond to an application for which the node 110 does not switch data, or else if it is not possible to identify an application based on these identifiers, then an error message is transmitted to the node 100.

According to another example, if an error message is transmitted, this message may advantageously be an SCTP packet comprising an Abort error code. According to one alternative, the error message may furthermore comprise a failure code allowing the node 100 to identify the cause, whether this be incorrect formation of the SCTP packet transmitted to the node 110 or else that the node 110 was not selected correctly or else that the identifiers were not set correctly.

According to one example, the first destination port identifier set in the header of the SCTP protocol is a port dedicated to the multiplexing method facilitating the processing to be performed on the received packet for the node 110. According to one alternative, the dedicated port used as first identifier may be port number 1 used in particular by the TCPMux protocol, specified in document IETF RFC 1078, thus making it possible to identify a common multiplexing port for a variety of transport protocols. According to one alternative, the first destination port identifier corresponds to a port already used for an application based on SCTP, for example assigned by the IRNA, thus avoiding having to resort to a new destination port number.

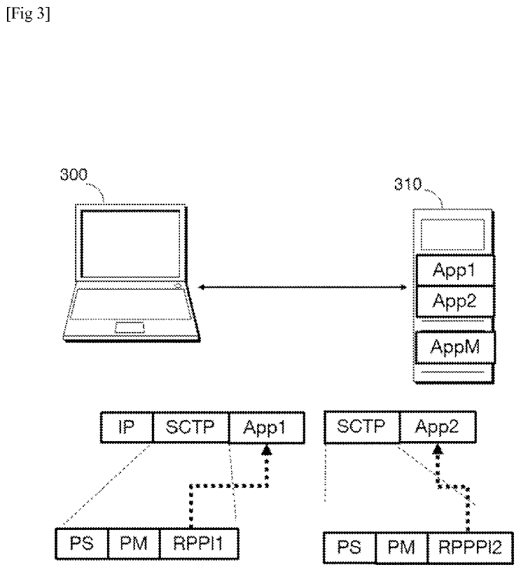

Reference is now made to [FIG. 3], which shows a simplified view of a communication between two nodes according to another aspect of the invention.

As in [FIG. 1] and [FIG. 2] for the respective nodes 400, 410, 100, 110, a node 300, corresponding to a terminal device, transmits application data of the applications App1, App2 to a node 310, corresponding to a proxy device, and transmits IP packets comprising the (source) IP address of the node 300, the (destination) IP address of the node 310, the (source) port PS of the SCTP transport protocol, the (destination) port of the SCTP transport protocol and application data relating to the applications App1 and App2.

According to this aspect of the invention, an application AppM relating to the SCTP protocol, called generic application, is also deployed on the node 310. The applications App1 and App2 may, according to one example, be implemented in equipments separate from the node 310.

The SCTP protocol used to transport the data of the applications App1 and App2 comprises a header comprising the source port PS and the destination port PM. Unlike [FIG. 1], in which the destination ports (P1 and P2 as a reminder) distinguished the applications (respectively App1 and App2), and [FIG. 2], in which the destination port P0, although common to the two applications App1 and App2, did not specifically identify an application, the destination port PM of the SCTP protocol unambiguously identifies the generic application AppM. All of the SCTP association packets comprising the destination port PM are thus routed to the application AppM. The port PM is indeed specific to the generic application, but as a single port is requested addressing the problem in terms of the availability of ports. Independently of the application App1 and App2 receiving the packets transmitted to the node 310, these are routed to the application AppM and therefore do not make it possible to differentiate the data of the applications App1 and App2. The node 310, by way of the application AppM, comprises a mediation device for the data streams intended for the user applications App1 and App2. Indeed, the node 310, upon receiving the SCTP request packets, uses an identification datum, respectively RPPI1 (Required Payload Protocol Identifier 1) and RPPI2 corresponding to identifiers of applications App1 and App2 requested by the node 310. These identifiers transmitted in a single request message or in two separate request messages are present in the fragments of the SCTP protocol in order to verify that the applications App1 and App2 indeed form part of the applications for which the proxy node 310 provides mediation. If so, the node 310 transmits a consent message, for example using the SCTP protocol, to the node 300 informing it that an SCTP connection for the application App1 may be made between the node 300 and the node 310, this connection being made via the generic application AppM. This aspect of the invention therefore makes it possible, like the first aspect of the invention, to be able to multiplex application streams relating to a plurality of applications, while at the same time preserving the destination ports used to route SCTP packets.

According to one alternative, the node 310 may furthermore use the destination port identifier PM in addition to the requested user application identifiers (here RPPI1 and RPPI2) to verify that the user applications App1 and App2 determined based on these identifiers form part of the applications for which the proxy node 310 provides mediation.

According to one example, the consent message comprises an identifier PPI1 (respectively PPI2) corresponding to the application for which the success message is transmitted to the node 100 and that may be used to mark the fragment comprising the data of the application App1 (respectively App2) transmitted to the node 310 when sending these data to the node 310.

According to one example, the node 300 then transmits, to the node 310, an SCTP packet comprising the header containing the destination port PM and an identifier PPI1 (respectively PPI2) corresponding to the application App1 (respectively App2) obtained in the response message received or else stored in the node 300. Upon receipt, in accordance with the transmitted success message, the node 310 transmits the application data relating to the application App1 (respectively App2) to the application App1 (respectively App2) or to the entity responsible for receiving and processing these application data present in the SCTP fragments.

According to one example, if the application App1 does not form part of the applications for which the node 310 provides mediation, a failure message is transmitted to the node 300 thus indicating thereto that the node 310 is not able to receive and where applicable to transfer, to a separate entity, the data relating to the application App1 for which the node 310 was called upon via the received association packet.

According to another example, the success message comprises all of the identifiers, for example PPI1 and PPI2, of the applications for which the node 310 provides mediation independently of the identifiers of the user applications requested by the node 300.

Like for the nodes of [FIG. 2], the nodes 300 and 310 may comprise the two devices, specifically the terminal device and the mediation device, and use them depending on the node that initiates the SCTP connection.

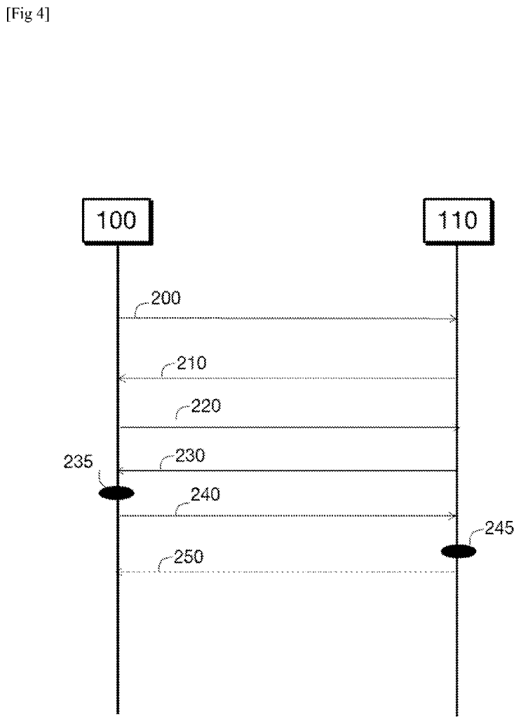

With reference to [FIG. 4], an overview of the method for switching a datum relating to an application and of the configuration method are presented according to a first embodiment of the invention. In this [FIG. 4], two nodes 100 and 110 communicate for example via a communication network, such as the Internet, a mobile infrastructure, a company network or any type of infrastructure allowing the node 100 and the node 110 to exchange SCTP packets.

In a step 200, the node 100, comprising a configuration device, transmits an SCTP INIT message to the node 110. This SCTP message comprises, more specifically, an INIT control fragment for establishing an association with the node 110.

In response to the SCTP INIT message received from the node 100, the node 110 transmits, in step 210, to the node 100, an SCTP INIT ACK message to the node 100 in step 210. This message comprises in particular an INIT ACK control fragment and an item of cookie state information.

In response to the received SCTP INIT ACK message, the node 100 transmits, to the node 110, a COOKIE-ECHO SCTP response message in step 220. This message makes it possible to finalize the SCTP association between the nodes 100 and 110, initialized by the node 100. The message comprises a fragment containing the value of the cookie state received in the SCTP INIT ACK message.

In response to the received COOKIE-ECHO message, the node 110 transmits, in step 230, an SCTP COOKIE-ACK message after having verified the authenticity of the value of the received cookie state. This COOKIE-ACK message acknowledges the COOKIE-ECHO message and the SCTP session is effectively established between the node 100 and the node 110 once this message has been received by the node 100.

Once the SCTP session has been established, the node 100 transmits application data relating to an application App1 to the node 110 in a step 240. More precisely, the SCTP message transmitted by the node 100 comprises a header in which the destination port is a port not specific to one application, but a port common to a set of applications. The SCTP message furthermore comprises at least one fragment comprising an identifier of the application App1, such as a character string identifying the application App1, and also application data intended for a process or an entity responsible for receiving, processing and transmitting data of the application App1. The node 100, based on a configuration device, in a step 235, parameterizes the SCTP packet comprising the header and the at least one fragment, and transmits, in step 240, the parameterized packet to the node 110, this node 110 comprising a switching device. Upon receipt of the SCTP message, the node 110 comprising the switching device verifies, in a step 245, that the destination port identifier and the application identifier that are received in the SCTP packet correspond to an application for which the switching device routes the application data, and if so, the switching device transmits the application data of the application App1 to the entities responsible for the application App1. In the unfavorable case, in which the identifiers of the header and of the fragment do not make it possible to identify an application or if the identified application does not form part of the applications for which the data are switched by the node 110, the node 110 transmits an error message, for example an SCTP message comprising an ABORT fragment, to the node 100 in a step 250.

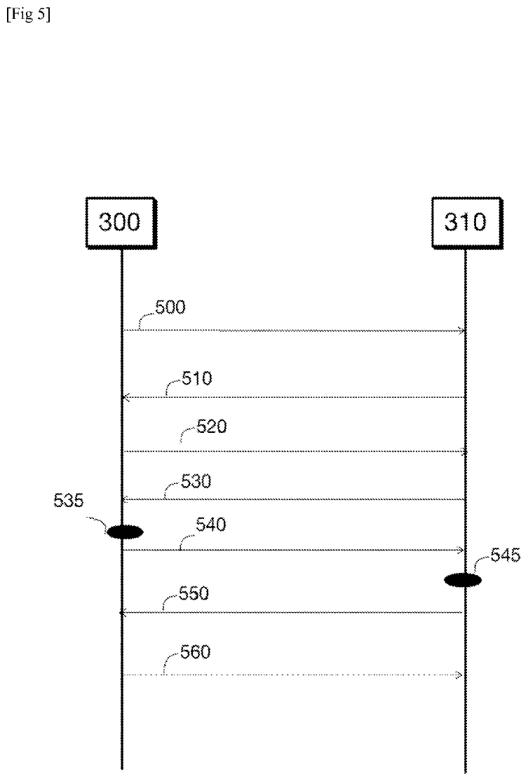

Reference is now made to [FIG. 5], which shows an overview of the method for mediating a plurality of applications by way of a generic application and of the parameterization method according to one embodiment of the invention.

The first four steps 500, 510, 520, 530 are equivalent to the respective steps 200, 210, 220, 230, with the difference that the destination port of the header of the messages 300 and 320 is a source port corresponding to a generic SCTP mediation application. Following the receipt of the COOKIE-ACK message in step 330, the nodes 300 and 310 have established an SCTP session based on a generic mediation application.

In a step 535, the node 300 parameterizes an SCTP packet with a header comprising the destination port corresponding to a generic mediation application and with a data fragment comprising application identifiers requested by the device 300. The requested identifiers correspond to identifiers for which the node 300 wishes to ascertain whether the generic application provides mediation for the application data of the applications corresponding to these identifiers. In a step 540, the node 300 transmits, to the node 310, an SCTP request message the header of which contains the destination port parameterized with an identifier of the generic application, and at least one fragment comprising one or more user application identifiers requested by the node 300. The node 300, through this message, indicates to the node 310 that it wishes to ascertain whether the node 310 accepts receiving data and transmitting them to software entities present on the node 310 or to nodes separate from the node 310 for one or more user applications the identifier or the identifiers of which are contained in the fragment of the SCTP request packet. The node 300 may choose to transmit one request message per user application or else to transmit one request message for a set of user applications.

Upon receipt of the request message, the node 310 examines, in a step 545, whether it provides mediation for the identifier or the identifiers that are received and transmits, to the node 300, in a step 550, in response to the request message, a consent message indicating to the node 300 that it is able to receive SCTP messages for the user application or the user applications for which the identifier or the identifiers have been received. In this favorable case, the node 300 may transmit, in a step 560, SCTP packets comprising a user datum specific to the application or to one of the applications for which the node 300 transmitted a success message.

If only some of the user applications corresponding to the received identifiers are actually managed by the node 310, the node 310 may transmit, in step 550, the list of identifiers corresponding to the applications for which it provides mediation via the generic application. According to another example, the node 310 may also inform the node 300 of the applications for which it provides mediation by transmitting their identifiers, independently of the identifier or the identifiers received from the node 300. According to yet another example, the node 310 may transmit a failure message, for example comprising an ABORT fragment, if none of the received identifiers corresponds to an application for which it provides mediation, possibly thus terminating the SCTP session between the node 300 and the node 310.

It should be noted that the embodiments are described using the SCTP protocol, but these embodiments could also be proposed with a stream transport protocol having features of the transport layer equivalent to the SCTP protocol.

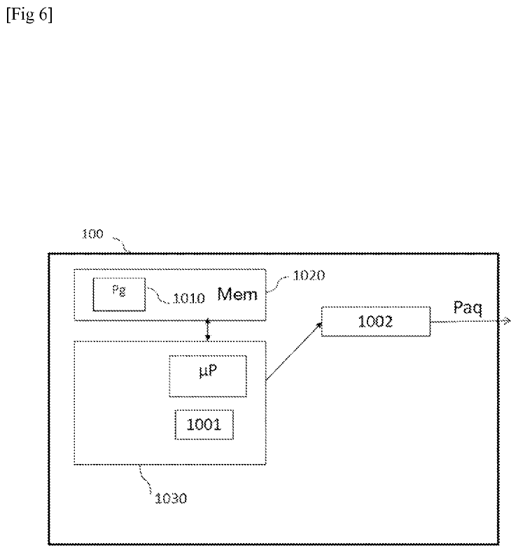

With reference to [FIG. 6], a device for configuring a packet of a stream transport protocol is presented according to one embodiment of the invention.

Such a device 100, also called terminal device, may be implemented in a user equipment or else a gateway of a personal network. It may also be implemented in an application server, in a router of a communication network or of an intermediate equipment (DPI (Deep Packet Inspection) or firewall) or else in an equipment of a mobile network (access gateway, server in an MEC (Mobile Edge Computing) architecture).

For example, the device 100 comprises a processing unit 1030, equipped for example with a microprocessor pP, and driven by a computer program 1010, stored in a memory 1020 and implementing the determination method according to the invention. On initialization, the code instructions of the computer program 1010 are for example loaded into a RAM memory before being executed by the processor of the processing unit 1030.

Such a device 100 comprises:
a parameterization module 1001, able to parameterize the packet with a first destination port identifier in the header and with a second identifier specific to an application in the data fragment,
a transmitter 1002, able to transmit the parameterized packet to a multiplexing device.

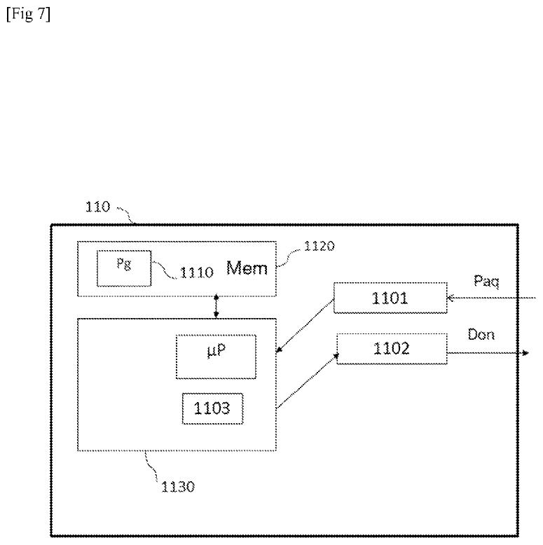

With reference to [FIG. 7], a device for switching a datum relating to an application is presented according to one embodiment of the invention.

Such a device 110, also called multiplexing device, may be implemented in an application server, in a router of a communication network or of an intermediate equipment (DPI (Deep Packet Inspection) or firewall) or else in an equipment of a mobile network (access gateway, server in an MEC (Mobile Edge Computing) architecture). The device 100 may also be implemented in a user equipment.

For example, the device 110 comprises a processing unit 1130, equipped for example with a microprocessor pP, and driven by a computer program 1110, stored in a memory 1120 and implementing the determination method according to the invention. On initialization, the code instructions of the computer program 1110 are for example loaded into a RAM memory before being executed by the processor of the processing unit 1130.

Such a device 110 comprises:
a receiver 1101, able to receive, from a terminal device, the packet Paq of the stream transport protocol comprising a header containing a first destination port identifier common to the plurality of applications, and the data fragment comprising a second identifier specific to the application,
a determination module 1103, able to determine the application on the basis of the first and the second identifiers that are received,
a transmitter 1102, able to transmit the datum Don to an entity responsible for processing the datum of the application if the application is determined.

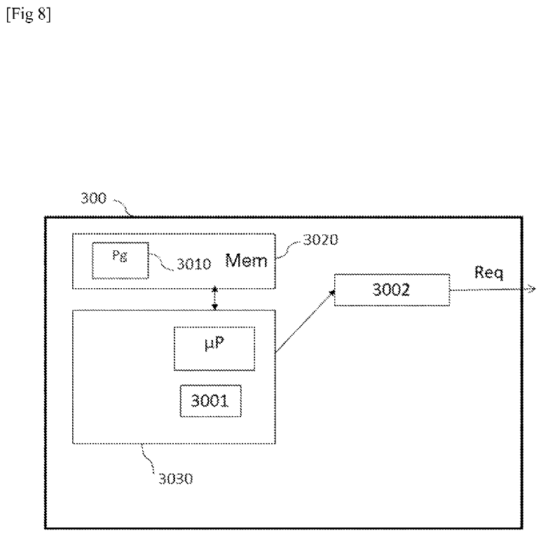

With reference to [FIG. 8], a device for parameterizing a stream control transport protocol packet is presented according to one embodiment of the invention.

Such a device 300, also called terminal device, may be implemented in a user equipment or else a gateway of a personal network. It may also be implemented in an application server, in a router of a communication network or of an intermediate equipment (DPI (Deep Packet Inspection) or firewall) or else in an equipment of a mobile network (access gateway, server in an MEC (Mobile Edge Computing) architecture).

For example, the device 300 comprises a processing unit 3030, equipped for example with a microprocessor pP, and driven by a computer program 3010, stored in a memory 3020 and implementing the determination method according to the invention. On initialization, the code instructions of the computer program 3010 are for example loaded into a RAM memory before being executed by the processor of the processing unit 3030.

Such a device 300 comprises:
a determination module 3001, able to determine a request packet Req of the stream control transport protocol, comprising a data fragment comprising an identification datum of a user application requested by the terminal device,
a transmitter 3002, able to transmit the determined request packet to the proxy device.

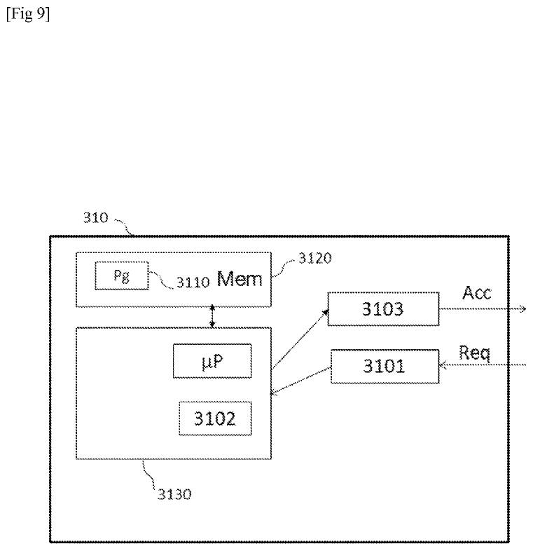

With reference to [FIG. 9], a device for mediating a plurality of applications by way of a generic application is presented according to one embodiment of the invention.

Such a device 310, also called proxy device, may be implemented in an application server, in a router of a communication network or of an intermediate equipment (DPI (Deep Packet Inspection) or firewall) or else in an equipment of a mobile network (access gateway, server in an MEC (Mobile Edge Computing) architecture). The device 100 may also be implemented in a user equipment.

For example, the device 310 comprises a processing unit 3130, equipped for example with a microprocessor pP, and driven by a computer program 3110, stored in a memory 3120 and implementing the determination method according to the invention. On initialization, the code instructions of the computer program 3110 are for example loaded into a RAM memory before being executed by the processor of the processing unit 3130.

Such a device 310 comprises:
a receiver 3101, able to receive, from the terminal device, a request packet Req of the stream control transport protocol comprising a data fragment containing an identifier of a user application requested by the terminal device,
a verification module 3102 able to verify that the requested user application is an application of the plurality,
a transmitter 3103, able to transmit, to the terminal device, a consent message Acc if the requested user application is an application of the plurality.

1. A switching method comprising:
switching a datum relating to an application transported in a data fragment of a packet of a Stream Control Transport Protocol stream transport protocol, implemented by a multiplexing device able to transfer data relating to a plurality of applications to processing entities, the switching comprising:
receiving, from a terminal device, the packet of the stream transport protocol comprising a header containing a first destination port identifier common to the plurality of applications, and the data fragment comprising a second identifier specific to the application,
determining the application on the basis of the first identifier and the second identifier that are received; and
in response to the determining of the application is being successful, transmitting the datum to an entity responsible for processing the datum of the application.

2. The switching method as claimed in claim 1, in response to the determining of the application being unsuccessful, transmitting an error message to the terminal device.

3. The switching method as claimed in claim 2, wherein the error message is a packet of the stream transport protocol comprising a fragment containing an Abort error code.

4. The switching method as claimed in claim 2, wherein the error message comprises a cause of failure intended for the application implemented in the terminal device.

5. The switching method as claimed in claim 1, wherein the first destination port identifier is a port identifier dedicated to the switching method.

6. The switching method as claimed in claim 1, wherein the first destination port identifier is a port identifier already allocated for the TCPMux protocol.

7. The switching method as claimed in claim 1, wherein the first destination port identifier is a port identifier allocated for an application based on the SCTP protocol.

8. A configuration method comprising:
configuring a packet of a Stream Control Transport Protocol stream transport protocol, the packet comprising a header and a data fragment, the configuring being implemented by a terminal device able to transmit a datum relating to an application to a multiplexing device, and comprising:
parameterizing the packet with a first destination port identifier in the header and with a second identifier specific to the application in the data fragment; and
transmitting the parameterized packet to the multiplexing device.

9. The configuration method as claimed in claim 8, furthermore comprising receiving an error message if no application is determined by the multiplexing device based on the first identifier and the second identifier that are parameterized.

10. A switching device able to transfer data relating to a plurality of applications to processing entities, one of the data being transported in a data fragment of a packet of a Stream Control Transport Protocol stream transport protocol, comprising:
a receiver configured to receive, from a terminal device, the packet of the stream transport protocol comprising a header containing a first destination port identifier common to the plurality of applications, and the data fragment comprising a second identifier specific to the application;
at least one processor configured to determine the application on the basis of the first identifier and the second identifier that are received; and
a transmitter configured to transmit the datum to an entity responsible for processing the datum of the application in response to the application being determined.

11. A device for configuring a packet of a Stream Control Transport Protocol stream transport protocol, the packet comprising a header and a data fragment, the device comprising:
at least one processor configured to parameterize the packet with a first destination port identifier in the header and with a second identifier specific to an application in the data fragment; and
a transmitter configured to transmit the parameterized packet to a multiplexing device.

12. (canceled)

13. At least one non-transitory computer-readable medium comprising instructions stored thereon for implementing a switching method when the program is executed by at least one processor of a multiplexing device, the multiplexing device being able to transfer data relating to a plurality of applications to processing entities, wherein the switching method comprises:
switching a datum relating to an application transported in a data fragment of a packet of a Stream Control Transport Protocol stream transport protocol, the switching comprising:
receiving, from a terminal device, the packet of the stream transport protocol comprising a header containing a first destination port identifier common to the plurality of applications, and the data fragment comprising a second identifier specific to the application;
determining the application on the basis of the first identifier and the second identifier that are received; and
in response to the application being determined, transmitting the datum to an entity responsible for processing the datum of the application.

14. At least one non-transitory computer-readable medium comprising instructions stored thereon for implementing a configuration method when the program is executed by at least one processor of a terminal device able to transmit a datum relating to an application to a multiplexing device, wherein the configuration method comprises:
configuring a packet of a Stream Control Transport Protocol stream transport protocol, the packet comprising a header and a data fragment, the configuring comprising:
parameterizing the packet with a first destination port identifier in the header and with a second identifier specific to the application in the data fragment; and
transmitting the parameterized packet to the multiplexing device.
